(19) United States
(12) Patent Application Publication
(10) Pub. No.: US 2007/0172300 A1
(43) Pub. Date: Jul. 26, 2007

(54) WRITING IMPLEMENT

(76) Inventor: Anthony Wlodarczyk, Yucaipa, CA (US)

Correspondence Address: JONES DAY, 222 EAST 41ST ST, NEW YORK, NY, 10017, US

(21) Appl. No.: 10/598,232

(22) PCT Filed: Feb. 23, 2005
(86) PCT No.: PCT/FR05/00432

§ 371 Date: Aug. 22, 2006

(30) Foreign Application Priority Data
Feb. 23, 2004 (FR) 0401788

(51) Int. Cl. B43K 7/12; B43K 24/02

(52) U.S. Cl. 401/108; 401/107

(57) ABSTRACT

A writing implement that includes a body having an opening through which a writing tip passes along a longitudinal direction, and a slot extending approximately along the longitudinal direction; a support on which the writing tip is mounted. the support being placed inside the body; a strip that includes a first portion fixed to the support, a central portion and an end portion guided along a curved path, the strip being flexible and capable of being moved between two positions, namely a writing position in which said strip gives access to the opening and a stowing position in which the strip closes off the opening; and a button connected to the support, the button being capable of being moved along the slot between a distal position relative to the opening, for which the support and the strip are in the stowing position, and a proximal position relative to the opening, for which the support and the strip are in the writing position.

This application is a national stage application of PCT/FR2005/000432, filed on Feb. 23, 2005.

### FIELD OF INVENTION

The embodiments of the present invention relates to writing implements.

### BACKGROUND OF INVENTION

More particularly, the embodiments of the present invention relates to a writing implement comprising: a body having an opening, through which a writing tip passes along a longitudinal direction, and a slot extending approximately along said longitudinal direction; a support on which the tip is mounted, said support being placed inside the body and able to move along the longitudinal direction between a writing position, in which the tip is brought outside the body, and a stowing position, in which the tip is stowed inside the body; a strip comprising a first portion fixed to the support, a central portion and an end portion guided along a curve path, said strip being flexible and able to move between two positions, namely a writing position in which it gives access to the opening and a stowing position in which it closes off the opening; and a button.

Document DE 87 07 226 U describes an example of such a writing implement, in which the strip is fastened at one of its ends to the button and at the other end to the support. The writing implement includes means for guiding the movement of the strip inside the body. The movement of the button is transmitted to the support via the strip, in such a way that the movement of the button is the reverse of that of the writing tip. The user must keep the button in a position away from the opening while he is writing. This is not comfortable.

### SUMMARY OF INVENTION

The embodiments of the present invention seeks in particular to mitigate this drawback.

Therefore, according to the embodiments of the present invention, an implement of the kind in question is characterized in that the button is connected to the support and is able to move along the slot between a distal position relative to the opening, for which the support and the strip are in the stowing position and a proximal position relative to the opening, for which the support and the strip are in the writing position, in that the body has a lower face and an upper face that are connected together by at least one lateral face of small height, so as to produce a writing implement of substantially flat shape, and in that the slot is made in one of the upper and lower faces, and the opening is made in the lateral face along which the end portion of the strip moves between the writing position and the stowing position.

Thanks to these dispositions, a writing implement easier to use is obtained, since the user naturally keeps the tip in the expelled position when the user presses the front end in order to write.

In addition, the writing implement has advantageous ergonomic features, since the button, which is able to move along the slot, is placed on one of the upper and lower faces of larger dimensions than the lateral face. This allows the implement to be handled more easily.

Moreover, thanks to these dispositions, the writing instrument is better sealed, since the opening made on the lateral face has a small height, limiting the ingress of air into the body and therefore limiting the risk of the tip drying out. The width of the strip is also small, thereby limiting the transverse deformations of the strip, which could impede the way in which it is guided or could impair the sealing.

Finally, the strip is placed perpendicular to the upper and lower faces and may thus have a larger radius of curvature than if it were placed parallel to one of the upper and lower faces. This prevents too large a deformation stress being applied to it and therefore prevents it from being excessively weakened.

In various embodiments of the writing implement according to the embodiments of the present invention, one may have recourse in addition to one or more of the following dispositions:
the button is connected to the support by a lug that passes through the slot, said lug being fixed by a tongue perpendicular to the first portion of the strip;
the lug, the tongue and the strip are made as one piece;
the upper and lower faces are substantially oval;
the button has a surface facing the body that extends from the lug over a length suitable for entirely covering the slot in the stowing position;
the support butts against the internal wall of the body during its displacement toward the writing position;
the end portion of the strip possesses an oblong window which, in the writing position, is positioned so as to face the opening for the passage of the writing tip;
the first portion of the strip is curved in the form of a U, the translation of the button causing a displacement of the first portion of the strip in the same sense and a displacement of the end portion of the strip in the opposite sense;
the first portion of the strip is joined to the central portion at an angel, the translation of the button causing translation of the first portion and displacement of the central portion and of the end portion in the same sense; and
the writing tip is a felt tip.

Other features and advantages of the embodiments of the present invention will become apparent over the course of the following description given by way of a nonlimiting example, in conjunction with the appended drawings.

### BRIEF DESCRIPTION OF THE DRAWINGS

FIG. 1 is a schematic bottom view of the writing implement according to a first embodiment of the present invention, in the stowing position;

FIG. 2 is a view similar to FIG. 1 of the writing implement in the writing position;

FIG. 3 is a side view of the writing implement of the first embodiment of the present invention; and

FIG. 4 shows a partial schematic view, as in the above first embodiment, of the writing implement according to a second embodiment of the present invention.

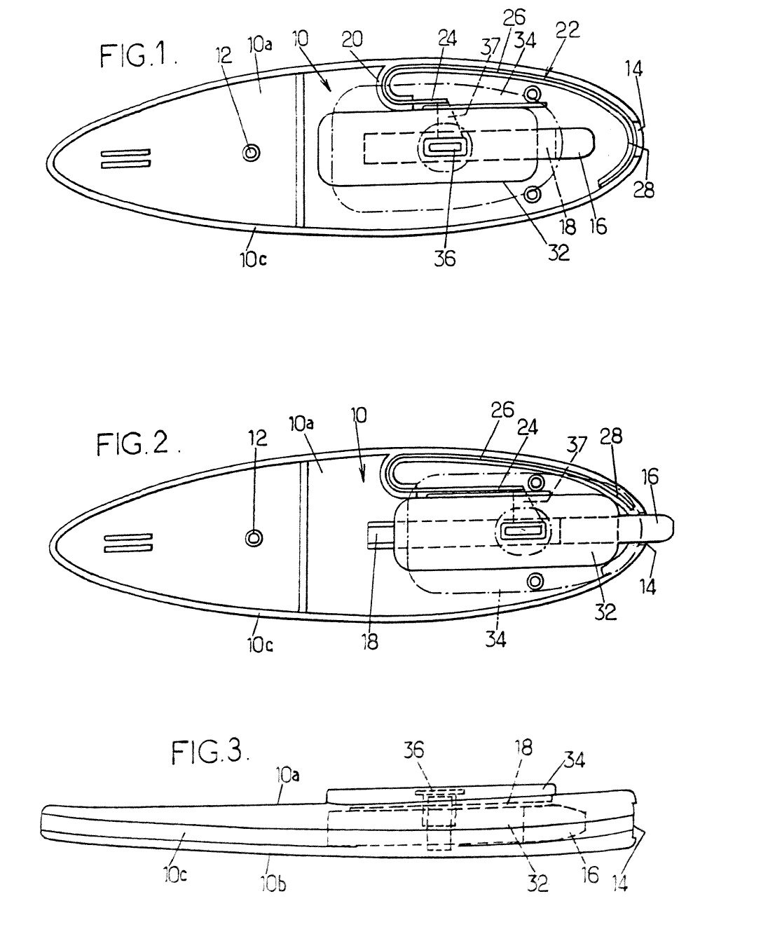

In the various figures, the same references denote identical or similar elements.

FIG. 1 illustrates the writing implement according to the embodiments of the present invention in the stowing position. Said writing implement comprises a body 10 formed by half-shells which are fixed to each other by interlocking of cylindrical elements 12. The body 10 comprises an upper face 10a, a lower face 10b and a lateral face 10c of thickness “e”, so that the body is substantially flat. As shown in FIG. 1, the upper 10a and lower 10b faces are oval shape. The lateral face of 10c at one of the rounded ends includes an opening 14 intended for the passage of a writing tip 16. The upper face 10a includes a slot 18.

This body also includes, on one of its internal lateral parts, a guiding element 20 formed by part of the lateral face 10c, which guiding element extends at one of its ends on either said of the opening 14, the other end of which is being curved in the form of a U, one branch of which is located along the lateral face 10c. Said guiding element 20 may be a hollow element, one wall of which is formed by the lateral face of 10c of the body 10 and parallel second wall, or else it may be formed from a single wall, namely the lateral face 10c of the body, which forms a guide for a strip 22.

Inside the body 10, the flexible strip 22 slides in the guiding element 20 and comprises three portions: a first portion 24, which slides inside the first end of the U-shaped curved guiding element 20; a central portion 26, which slides in that part of the guiding element 20 which is formed partly by the latterly face 10c; and an end portion 28, which is placed at the other end of the guiding element 20 and is guided along a curved path designed by the lateral face 10c.

Also placed inside the body is a support 32 on which the writing tip 16 is mounted, said support containing the ink reservoir connected to the writing tip 16. This support 32 is fastened to the writing tip 16. This support 32 is fastened to the writing tip 16 and its displacement consequently causes that of the writing tip 16 in the same direction. This support 32 is able to move along the slot 18 between a distal position relative to the opening 14, for which the support 32 and the strip 22 are in the stowing position, and a proximal position relative to the opening 14, for which the support 32 and the strip 22 are in the writing position. This support 32 is joined to the first portion 24 of the strip 22.

A button 34 slides in the slot 18 made in the upper face 10a of the body 10 between a stowing position and a writing position. It is fitted onto a lug 36, which is turned towards the inside of the body. Said lug 36 is positioned in a plane perpendicular to the plane of the button 34 and passes through a housing in the support 32 and through the slot 18. The button 34 is fastened to the lug 36 in such a way that the translation of said button 34 causes simultaneous displacement of the support 32 and of the strip 22.

The button 34 has a surface facing the body that extends from the lug 36 over a length suitable for covering the slot 18 in the stowing position, in order to provide a certain amount of sealing between the slot and the button.

The first portion 24 of the strip 22 is joined via a tongue 37, perpendicular to said first portion 24, to the lug 36, passing through the support 32 and the slot 18 of the body. Advantageously, the lug, the tongue 37 and the slot 22 are made as one piece. In the stowing position, the end portion 28 of the strip 22 faces the opening 14 and closes off the latter.

The expulsion of the writing tip 16 is controlled by a movement of the button 34 toward the front end, this being intuitive for the user. In addition, the user naturally keeps the button 34 in the forwarded position when he takes hold of the writing implement in order to write, in such a way that it is not necessary to provide means for locking the support 32 in the writing position or in the stowing position.

The operation of the embodiments of the present invention may be described in the following manner: in the stowing position, that is to say when the writing tip 16 is located inside the body, the support 32 is in a distal position relative to the opening 14, the end portion 28 of the strip 22 then closing off the opening 14 of the body 10. This has the advantage of providing a writing implement with no cap which, because of its removable character, may be easily lost.

From this stowing position, the user makes the button 34 undergo a translation movement toward the opening 14. This translation causes displacement of the lug 36 in the same direction, that is to say it moves in the longitudinal direction toward the opening 14 and conveys, in the same direction, the support 32 containing the writing tip 16. Since the lug 36 is joined to the first portion 24 of the strip 22 via a tongue 37, said first portion 24 then undergoes a displacement in the same sense as that of the button 34, whereas the end portion 28 of the strip, located near the opening 14, undergoes a displacement in the reverse direction, that is to say it leaves free access to the writing tip 16, in the writing position.

In the writing position, in which the writing tip 16 is brought outside the body 10, the support 32 butts against the lateral face 10c of the body 10. The translational movement of the button 34 in the slot 18 is therefore limited. The button 34, the lug 36 and the support 32 are closer to the opening 14. The button is kept in the writing position only by friction in the slot 18 or by the user. However, locking means may be added for keeping the button 34 in this position while the writing tip 16 is being used.

To return to the stowing position, the button 34 is moved back by the user toward its initial position, causing displacement of the lug 36, the support 32 and consequently the strip 22. The end portion 28 of the strip 22 is brought back in front of the opening 14, which it closes off in the stowing position, and, with the button 34 covering the slot 18, ensures that the inside of the body 10 is sealed to a certain extent.

FIG. 3 shows a side view of the writing implement according to the embodiments of the present invention. As shown, said writing implement has a relatively small thickness “e” and a button 34 of flattened shape. The support 32 for the writing tip 16 has a smaller thickness than that of the body, in order to be able to be inserted thereinto. This is why the lug 36, joined at right angles to the first portion 24 via the tongue 37, has a height substantially equal to that of the body 10.

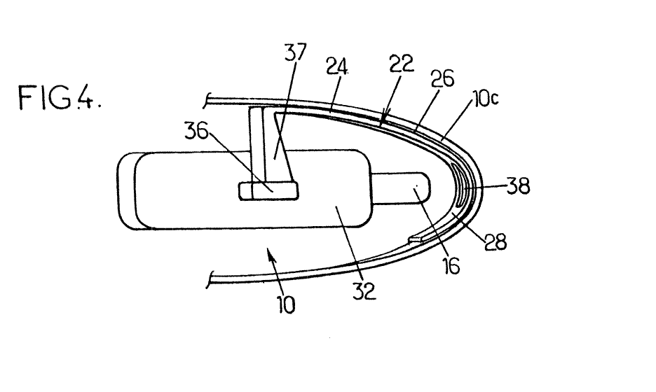

According to another embodiment as illustrated in FIG. 4, the first portion 24 of the strip 22, which is fixed to the tongue 37, extends in substantially a straight line from the support toward the front and is extended by the central part and the end portion 28. Translation of the button 34 along the longitudinal direction toward the opening 14 therefore causes translation of the first portion 24 and, consequently, displacement of the central portion 26 and the end portion 28 in the same sense as that of the translation of the button 34.

In FIG. 4, the end portion 28 of the strip 22 has an oblong window 38, for example a rectangular window, the length of which is greater than that of the opening 14 so that the tip can advance through said opening 14 during its displacement. Said window 38 is brought so as to face the opening 14 in the writing position, and is displaced in the stowing position so as to close off the opening 14. It will be apparent to those skilled in the art that this arrangement may be applied to the first embodiment described above.

In the embodiments shown, the strip 22 is positioned in a guiding element 20 on a lateral face 10c of the body of the writing implement. These embodiments are not limiting—the strip 22 may especially be positioned on the internal walls of the upper face 10a or lower face 10b in the same way, that is to say with a guiding element 20 possessing a curvature in the form of a U, the two branches of which are parallel to the upper face 10a and lower face 10b respectively, so as to guide the strip 22 in order to close off the opening 14.

The type of writing implement described above, which allows the writing tip 16 to be stowed in a closed space, is particularly applicable to a felt tip intended for highlighting a text.

1.-10. (canceled)

11. A writing implement comprising:
a body having an opening through which a writing tip passes along a longitudinal direction, and a slot extending approximately along the longitudinal direction;
a support on which the writing tip is mounted, said support being placed inside said body;
a strip comprising a first portion fixed to said support, a central portion and an end portion guided along a curved path, said strip being flexible and capable of being moved between two positions, namely a writing position in which said strip gives access to the opening and a stowing position in which said strip closes off the opening; and
a button connected to said support, said button being capable of being moved along the slot between a distal position relative to the opening, for which said support and said strip are in the stowing position, and a proximal position relative to the opening, for which said support and said strip are in the writing position.

12. A writing implement comprising:
a body having an opening through which a writing tip passes along a longitudinal direction, and a slot extending approximately along the longitudinal direction;
a support on which the writing tip is mounted, said support being placed inside said body;
a strip comprising a first portion fixed to said support, a central portion and an end portion guided along a curved path, said strip being flexible and capable of being moved between two positions namely a writing position in which said strip gives access to the opening and a stowing position in which said strip closes off the opening; and
a button connected to said support, said button being capable of being moved along the slot between a distal position relative to the opening, for which said support and said strip are in the stowing position, and a proximal position relative to the opening, for which said support and said strip are in the writing position,
wherein said body includes a lower face and an upper face connected together by at least one lateral face having a small height so as to produce a writing implement having a substantially flat shape, and
wherein the slot is made in one of the upper and lower faces, and the opening is made in the lateral face along which the end portion of said strip moves between the writing position and the stowing position.

13. The writing implement according to claim 12, wherein said button is connected to said support by a lug passing through the slot, the lug begin fixed by a tongue perpendicular to the first portion of said strip.

14. The writing implement according to claim 13, wherein the lug, the tongue and said strip comprise a unitary member.

15. The writing implement according to claim 12, wherein the upper and lower faces are substantially oval.

16. The writing implement according to claim 12, wherein said button includes a surface facing said body that extends from the lug over a length suitable for entirely covering the slot in the stowing position.

17. The writing implement according to claim 12, wherein said support butts against the internal wall of said body during its displacement in the writing position.

18. The writing implement according to claim 12, wherein the end portion of said strip possesses an oblong window which, in the writing position, is positioned so as to face the opening for the passage of the writing tip.

19. The writing implement according to claim 12, wherein the first portion of said strip is curved generally in the form of a U, the translation of said button causing a displacement of the first portion of said strip in the same direction, and a displacement of the end portion of said strip in the opposite direction.

20. The writing implement according to claim 12, wherein the first portion of said strip is joined to the central portion at an angle, the translation of the first portion and the displacement of the central portion and of the end portion being in the same direction.

21. The writing implement according to claim 12, wherein the writing tip includes a felt tip.

22. A writing implement comprising:
a body having an opening, through which a writing tip passes along a longitudinal direction, and a slot extending approximately along the longitudinal direction;
a support on which the writing tip is mounted, said support being placed inside said body,
a strip comprising a first portion fixed to said support, a central portion and an end portion guided along a curved path, said strip being flexible and capable of being moved between two positions, namely a writing position in which said strip gives access to the opening and a stowing position in which said strip closes off the opening; and
a button connected to said support, said button being capable of being moved along the slot between a distal position relative to the opening, for which said support and said strip are in the stowing position, and a proximal position relative to the opening, for which said support and said strip are in the writing position,
wherein said body includes a lower face and an upper face connected together by at least one lateral face having a small height so as to produce a writing implement having a substantially flat shape,
wherein the slot is made in one of the upper and lower faces, and the opening is made in the lateral face along which the end portion of said strip moves between the writing position and the stowing position, and
wherein the end portion of said strip possesses an oblong window which, in the writing position, is positioned so as to face the opening for the passage of the writing tip.
